(19) United States
(12) Patent Application Publication
(10) Pub. No.: US 2008/0251682 A1
(43) Pub. Date: Oct. 16, 2008

(54) Wall Hanger

(76) Inventor: Cedomir Repac, Brechen (DE)

Correspondence Address: CHARLES P. BOUKUS, JR., SUITE 202, 2001 JEFFERSON DAVIS HIGHWAY, ARLINGTON, VA, 22202, US

(21) Appl. No.: 11/783,810

(22) Filed: Apr. 12, 2007

(51) Int. Cl. F16B 45/00

(52) U.S. Cl. 248/546; 248/304

(57) ABSTRACT

The invention provides a fastening element for fastening objects to a wall comprising a body (16; 36) with a substantially flat rear side being adapted to butt against a wall, further comprising at least a first straight shaft (11, 13) penetrating the body (16, 36) at an angle with respect to the plane of the body's rear side, whereby the shaft (11, 13) being adapted to guide a pin-like fastening means to be driven into the wall for affixing the fastening element to the wall, the body further comprising at least one pre-fixing element (20, 22; 46, 48, 50) protruding from the body's rear side and being adapted to penetrate the wall when the body (16, 36) is brought in contact with the wall (FIG. 5)

### FIELD OF THE INVENTION

The present invention relates to the field of fastening element, in particular hangers or hooks being adapted to be affixed to a wall.

### BACKGROUND AND PRIOR ART

Wall hangers of different kinds are known in the prior art. For instance Austrian patent specification AT 15 19 11 discloses a hook-shaped wall hanger comprising at least two guiding holes for guiding a wall penetrating fastening pin therethrough. The two guiding holes are aligned at an angle with respect to a rear side of the hanger in such a way, that when the hanger is affixed to the wall, the guided pin is pointing downwards into the wall.

Another wall hanger is disclosed in the German patent specification DE 803 667. This hanger featuring a panel comprises at least one guiding shaft for guiding a fixing pin therethrough. Also here, the angle of the guiding shaft is about 45° with respect to the vertical surface of the wall. When affixed to the wall, the shaft-guided pin is pointing downwards with respect to a horizontal axis.

Due to the downward pointing fixing pins, the load limit or the hanger's maximum holding force, respectively can be optimized and enhanced. However, since the downward pointing pins have to be forced into the wall by making use of a tool, like a hammer, it is difficult, to keep the hanger at a predetermined position at the wall when the holding or affixing pin is driven into the wall in a non-perpendicular way with respect to the surface of the wall.

Especially when a head of the pin gets in contact with an outer rim of the hanger's guiding shaft, which appears typically just before reaching a final assembly position, the hanger becomes inevitably subject to an undesirable downward displacement.

Even though the guiding shaft provides a guiding for the fixing pin, the latter has to be retained in the hanger's shaft with the same hand which also keeps the hanger in a desired position at the wall. Hence, holding the hanger in place and retaining the fixing pin in the shaft has to be provided by a single hand of a user. While the other hand keeps hold on the fixing tool, a precise and reliable fixing or mounting of the hanger to a wall requires certain skills of a user.

Therefore, the invention aims to provide a fastening element intended to be affixed to a wall that can be mounted in an easy, fast and accurate way.

### SUMMARY OF INVENTION

The present invention provides a fastening element for fastening objects to a wall. The inventive fastening element comprises a body with a substantially flat rear side. This rear side is adapted to butt against a wall, such that nearly the entire rear side of the body gets in contact to the flat surface of a wall, in order to provide a reliable and secure fastening.

Further, the body has at least a first substantially straight shaft that penetrates the body at an angle with respect to the plane of the body's rear side. Hence, the at least first shaft completely intersects the panel-like structure of the body in a slanted or skewed way. The straight shaft is adapted to guide a pin-like fastening means, that has to be driven into the wall for affixing the fastening element to the wall.

The fastening means typically has a pointed tip and a flat head at its opposite end, the latter of which abuts against the body's front side, thereby exerting a clamping or holding force to the body when the pin-like fastening means reaches a final assembly position in the wall.

According to the invention, the body now further comprises at least one pre-fixing element, that is protruding from the body's rear side and which is adapted to penetrate the wall when the body is brought in contact with the wall. The protruding pre-fixing element serves to keep the fastening element's body in a predetermined position at the wall while the pin-like fastening means is driven into the wall by making use of a hammer or the like.

Compared to the pin-like fastening means, the pre-fixing means are adapted to provide a holding force that is sufficient to keep the fastening element at the desired position at the wall, whereas the pin-like fastening means are adapted to rigidly and firmly affix the fastening element to the wall in a final assembly position, in which the fastening element is adapted to provide a maximum holding force and a respective load.

When the fastening element according to the present invention is mounted or affixed to a wall, it can simply by pushed against the wall and comparable to the function of a thumb-tack, the prefixing element at least partially penetrates the wall in order to keep the fastening element at its predetermined position.

In such a provisional pre-fixing position, the user can now completely concentrate on inserting the pin-like fastening means into the straight shaft of the fastening element's body for affixing the fastening element firmly and rigidly to the wall. In this way, the user does no longer have to focus on keeping both, the pin-like fastening means and the fastening element itself in place during the affixing procedure, e.g. when driving the pin-like fastening means into the wall by means of a hammer.

Further, the pre-fixing stadium that is attainable by means of the pre-fixing elements is advantageous for provisionally mounting light-weight objects with the fastening elements to a wall. For instance, when fixing a light-weight picture frame or a poster to a wall, by making use of the inventive fastening elements, in a pre-fixing position, the object to be hung to the wall may be provisionally fixed with one or several inventive fastening elements. The user may properly adjust and align the object and may further examine and observe the pre-fastening position at a distance from the wall. In the pre-fixing position, the fastening elements may easily be removed from the wall and be re-affixed to the wall at a slightly different position.

According to a preferred embodiment of the invention, the at least one pre-fixing element is pointing in a direction substantially perpendicular to the plane of the body's rear side. In this way the pre-fixing of the entire fastening element can be achieved by simply pushing or forcing the fastening element's body against the wall, thus leading to a thumb-tack-like prefixing of the fastening element.

Also because of the pre-fixing elements are pointing substantially perpendicular to the plain of the body's rear side, while prefixing the fastening element to the wall, i.e. the pre-fixing element penetrating the wall, the fastening element's body does not become subject to a lateral movement.

According a further embodiment, the pre-fixing element is shaped as a pointed pin. The pointed or sharpened end of the pin is pointing away from the body's rear side. Hence, the combination of the pre-fixing element with the fastening element's body serves as a kind of thumb-tack.

According to another embodiment, the fastening element's body comprises at least a first and a second shaft, wherein the two shafts are arranged near a body's upper edge. At this upper border, the first and the second shafts are laterally, i.e. horizontally displaced. Further, the first and the second shafts are pointing downwards at a angle between 20° and 40° with respect to the surface normal of the body's rear side, wherein the surface normal defines an axis perpendicular to the plane defined by the body's rear side.

The downward pointing arrangement of the two shafts has to be regarded as running from the body's front side to the body's rear side. Consequently, the shaft end adjacent to the body's front side is closer or nearer to the upper edge of the body than that portion of the shaft adjoining to the body's rear side. In this way, the load capacity of the entire fastening element can be remarkably increased since the pin-like fastening means appointing downwards in the wall and is capable to withstand a maximum shear force.

Further, the first and second shafts are horizontally displaced from each other near the upper edge of the body. Additionally, they are directed towards each other also in the horizontal plane. Hence, each of the two shafts is tilted with respect to two directions. For instance the outer left shaft points downwards and as well to the right. Accordingly, the outer right shaft points downwards and as well to the left. Thus, in a horizontal projection, the two shafts point towards each other as seen from the front side of the body.

This two-fold skewed and tilted arrangement of the shafts further serves to increase the maximum holding force and to enhance the maximum load limit that can be provided by the fastening element.

According to a further preferred embodiment of the invention, the fastening element comprises at least three pre-fixing elements that are evenly distributed over the body's rear side. Typically, the three pre-fixing elements are arranged in a triangle-like geometry. Preferably, two of the three pre-fixing elements are arranged horizontally spaced apart from each other near the upper edge of the body's rear side, whereas the third pre-fixing element is arranged between the two upper pre-fixing elements in a horizontal projection but vertically shifted.

According to a further embodiment of the invention, the fastening element's body comprises at least four pre-fixing elements which are arranged at the corners of an imaginary rhombus at the body's rear side. Additionally or alternatively, the four pre-fixing elements may also be arranged in a rectangular or in a quadratic way.

By making use of several pre-fixing elements, the pre-fixing of the fastening element to the wall can be optimized. Consequently, a holding force provided by the fastening element in a pre-fixing stadium at the wall can be substantially increased. Further, by making use of at least two pre-fixing elements, it can be guaranteed that a pre-fixed fastening element does not become subject to an unintended twisting or rotative motion.

However, it may be already sufficient to provide two pre-fixing elements at the body's rear side. In general, these at least two pre-fixing elements may be arranged in various different configurations, like horizontally or vertically spaced from each other.

According to a further embodiment, the front side surface of the body is substantially flat and even in order to serve as a basis for attaching suction cup-based hooks or the like attachment means. In this way, the fastening element indirectly provides a fastening functionality. Particularly, in this embodiment it allows for a universal fixing of suction-cup based fixing means which can otherwise not directly be affixed to a wall that has a harsh or rough surface being unsuitable for a suction cup based attachment.

According to a further preferred embodiment of the invention, the body of the fastening element further comprises a lower hook-like portion that is arranged to hang objects thereon. The hook-like portion is arranged at the body's front side in such a way that the wall affixed fastening element serves as a hook-like fastener. The hook-like portion typically features a lower end that is curved or bended at an angle of about 180 degrees.

Consequently, the free end of the hook portion is typically pointing upwards when the fastening element is in its final assembly position at the wall.

According to a further embodiment, the hook portion is pivot-mounted to the body. Hence, the hook portion can be pivoted with respect to the fastening elements being mounted to the wall. Such a pivot-mounted hook portion can be advantageous for hanging objects on the fastening element. By tilting the hook portion away from the body, its hook-shaped free end becomes easier accessible for hanging objects thereon. As soon as an object is hooked in the free end of the hook portion, the latter may be tilted back and may abut against the body's front side.

According to another preferred embodiment; the body of the fastening element comprises plastic material, especially molded plastic material. Making use of plastic, the entire fastening element can be manufactured in a cost-efficient, fast and reliable way. Also it is fairly easy to provide various different shapes and geometries of fastening elements as well as various colours and surface finishes.

Additionally and alternatively, not only the body portion of the fastening element but the entire fastening element can comprise plastic material.

Even though plastic is the preferred material for the fastening element, the present invention is not limited at all to plastic material. Also various types of metals, such as brass, steel, aluminium or the like are within the scope of the present invention.

According to a further preferred embodiment, the pre-fixing elements are molded in the body. Especially, when the body is made of molded plastic material, the protruding pre-fixing elements can be integrally molded in the body.

According to another aspect, the invention provides a fastening means that is adapted to fit into at least one shaft of a fastening element according to the present invention. The fastening means comprises a wall-penetrating pointed pin that has a pan-head. Preferably, the fastening means comprises steel and has a diameter in the millimeter or sub-millimeter range.

Upon affixing of the fastening element by means of the pin-shaped fastening means, the pan-head of the fastening means abuts against the front side of the fastening element's body, thereby providing a sufficient clamping of the fastening element at the wall. According to a preferred embodiment, the fastening means' head further has a circumferential notch and an adjacent socket. The socket is adapted to abut against the front surface of the fastening elements, thereby providing a sufficient fixation or clamping effect.

The circumferential notch of the fastening means provides an effective point of application for various tools being adapted for removal of the fastening means from a wall, thus allowing for a disassembling of the fastening element from a wall. The fastening means and the fastening elements are consequently adapted for multiple use. They can be re-used at different positions at the same or at different walls.

### BRIEF DESCRIPTION OF THE DRAWINGS

Further embodiments and details of the present invention will be described in detail by making reference to the drawings in which:

FIG. 1 shows a front side illustration of a first embodiment of the fastening element,

FIG. 2 depicts a side view of the fastening element according to FIG. 1,

FIG. 3 shows a back side illustration of the fastening element according to FIGS. 1 and 2,

FIG. 4 shows a top view illustration of the fastening element,

FIGS. 5 and 6 depict two different illustrations of the fastening element according to FIG. 1 through FIG. 4,

FIG. 7 shows a side view of another embodiment of the fastening element,

FIG. 8 shows a back side illustration of the fastening element according to FIG. 7,

FIGS. 9-11 show various perspective illustrations of the fastening element according to FIGS. 7 and 8,

FIG. 12 shows a side view illustration of a pin-like fastening means,

FIG. 13 shows a cross-sectional view of the fastening means along A-A,

FIG. 14 shows a cross-sectional view of the fastening means according to FIG. 12 along B-B,

FIG. 15 shows another illustration of the fastening element according to FIG. 1 with visible shafts and

FIG. 16 depicts another top view illustration corresponding to FIG. 4.

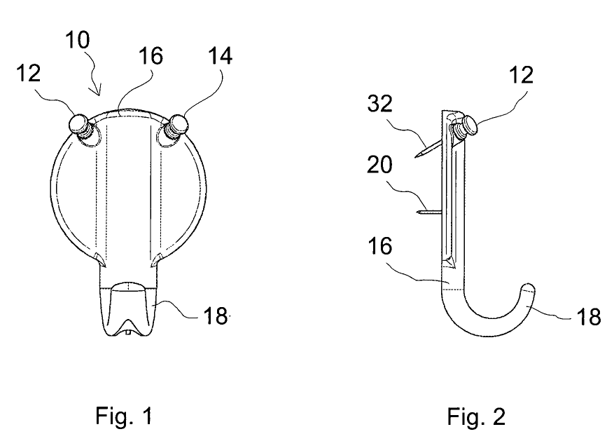

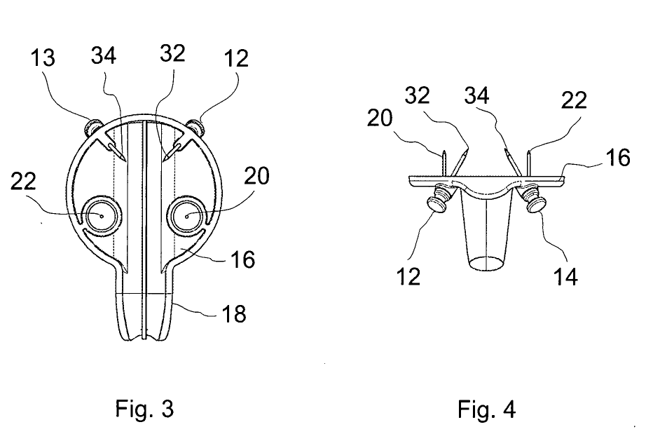

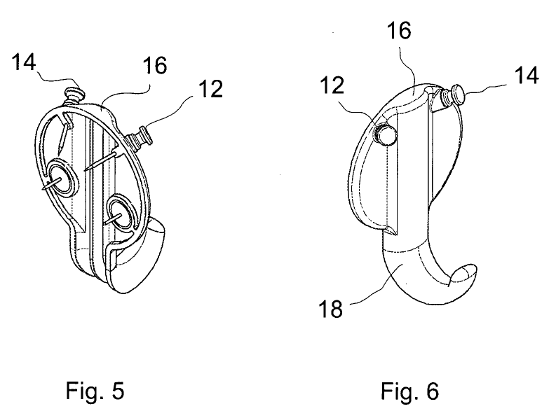

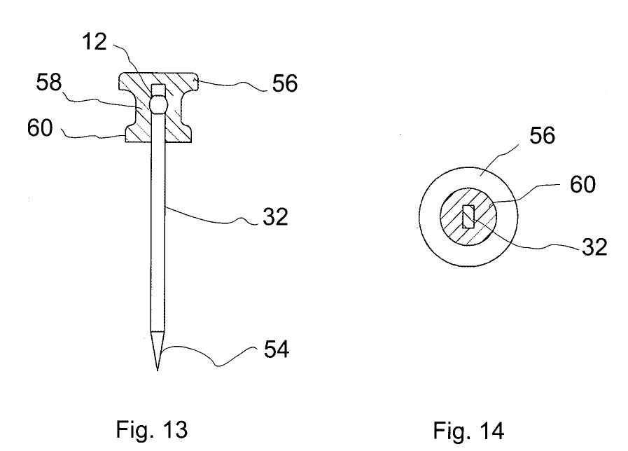

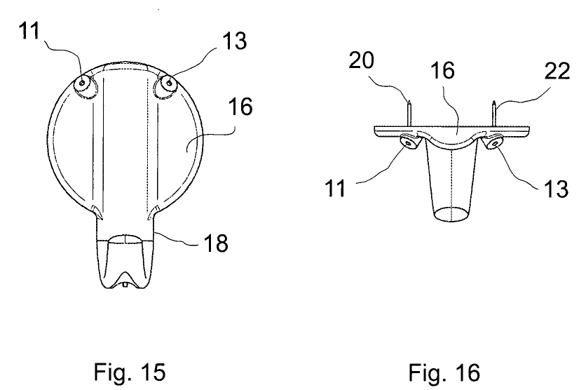

The fastening element according to FIGS. 1 through 6 as well as FIGS. 15 and 16 comprises a body 16 typically consisting of molded plastic. The body 16 has a flat panel-like shape and a substantially circular geometry with a hook portion 18 at its lower end. Near the upper edge of the body 16 there are provided two shafts 11, 13 that are adapted to guide a pin-like fastening means as illustrated in the FIGS. 12 through 14.

The nail-like fastening means 12, 14 has a pointed pin 32 featuring a pointed tip 54. This pointed tip 54 is typically slanted at an angle of about 30°, preferably 20° with respect to the direction of elongation of the pin 32. Further, the pin 32, 34 typically comprises a very hard and inflexible material, such like tempered steel.

The shafts 11, 13 of the fastening element's body 16 are tilted with respect to a horizontal as well as to a vertical direction according to the illustration as depicted in FIG. 1. Hence, as can be seen in FIG. 2, the pin 32 guided by the shaft 11 is pointing downwards into the wall. The tilt angle with respect to the horizontal axis is somewhere around 20°-40°, preferably around 30°.

Further, the two shafts 11, 13 are further oriented towards each other. Consequently, the shafts 11, 13 are not only pointing downwards into the wall but they are also tilted in a horizontal direction towards each other. This two-fold tilted arrangement is advantageous to reach an optimum holding force as well as for maximizing a shear force that can be provided by the fastening element in a terminal assembly position at the wall.

The skewed or tilted alignment of the two shafts 11, 13 can be seen in the top view illustration of FIG. 4 as well as in the side view illustration of FIG. 2, where the fastening pins 32, 34 protrude from the body's 16 backside.

Further, the figures illustrate two pre-fixing elements 20, 22 that are designed as pointed pins protruding perpendicular from the body's 16 rear side. The protrusion of the pre-fixing elements 20, 22 is comparable to the protrusion of the fastening means 32, 34 that are guided through the shafts 11, 13. The protrusion of the guided fastening means 32, 34 is preferably slightly larger than the protrusion of the pre-fixing elements 20, 22.

In the depicted illustration, all pre-fixing elements 20, 22 are almost equal in length. However, in order to cope with various wall compositions and configurations, the pre-fixing elements 20, 22 may also vary in length. Hence, the fastening element (10) may be equipped with two, alternatively also with three or four equally protruding pre-fixing elements or with differently protruding pre-fixing elements. Also regarding the respective wall properties, the overall length or protrusion of the pre-fixing elements may be adapted accordingly.

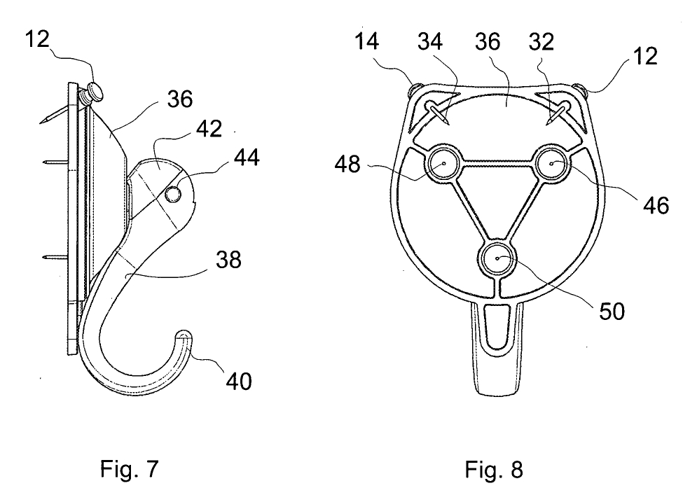

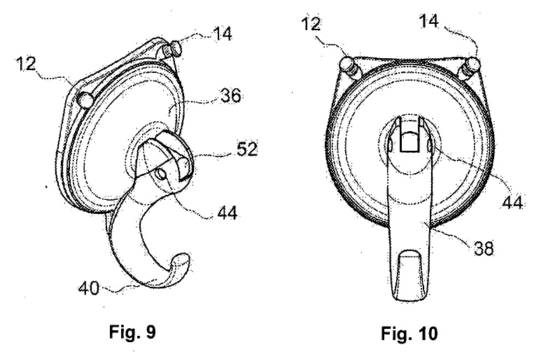

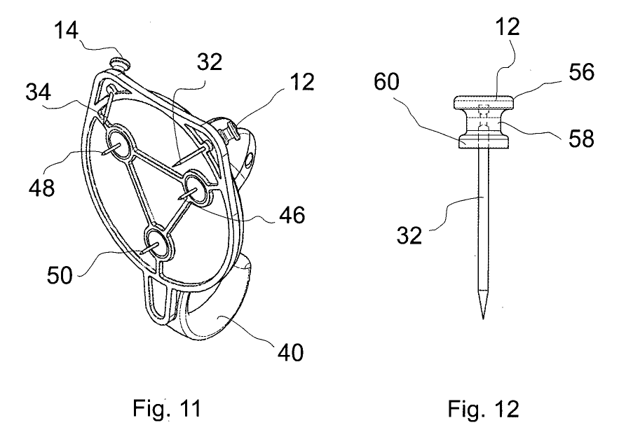

FIGS. 7 through 11 show another embodiment of a fastening element featuring a body (36) that has a slightly conical or dome-like shape. In the middle section of its front face, it features a protruding trunnion 52 that serves as a basis for a swivel-mounted or pivot-mounted hook portion 38 which in turn features an at least 180° bended hook tip 40. The entire hook portion 38 is pivotable around a pivot axis 44. The pivot mounting of the hook portion 38 provides a larger degree of flexibility of the fastening element which is advantageous for hanging objects on the hook portion 38, 40.

Comparable to the embodiment illustrated in FIGS. 1 through 6, also the embodiment shown in FIGS. 7 through 11 features the two-fold tilted shafts for guiding the pin-like fastening means 32, 34, 12, 14. Further, the embodiment shown in FIGS. 7 through 11 only has three pre-fixing elements 46, 48, 50 that are arranged in a triangle-like geometry at the body's 36 rear side.

FIGS. 12 through 14 further show the shape of the pin-like fastening means, having a flattened head 12 and an adjacent rim-like portion allowing for an easy disassembling of the wall-penetrating pin 32. The pin 32 typically has a pointed tip 54, which in turn features shoulders that are slanted at an angle of about 20° with respect to the long axis of the pin 32.

The pan head 12 of the pin further has a circumferential notch 58 and an adjacent socket (60). With its lower edge, the socket 60 is adapted to butt against the shafts 11, 13 of the fastening elements body 16. The radial expansion of the slightly protruding shafts 11, 13 as well as the radial expansion of the socket 60 fit to one another in such a way, that the circumference of the socket 60 and the circumference of the protruding portions of the shafts 11, 13 flush to one another in order to provide a shapely outer appearance of the entire fastening element.

Further, the notch-like or neck-like portion 58 of the head 12 of the pin 32 together with the outer rim 56 allows for a positive fitting with an appropriate tool for disassembling the pin 32 from the wall. The notch-like portion 58 therefore allows for a proper pulling out of the pin from the wall without damaging the region of the head 12, for instance in form of scratches or the like. Hence, the pin as well as the fastening element can be reused after a disassembling.

### LIST OF REFERENCE NUMERALS

10 hook
11 shaft
12 head
13 shaft
14 head
16 body
18 hook portion
20 pin
22 pin
32 pin
34 pin
36 body
38 hook
40 hook tip
44 axis
46 pin
48 pin
50 pin
52 trunnion
54 pointed tip
56 rim
58 neck
60 socket

1. A fastening element for fastening objects to a wall comprising a body (16, 36) with a substantially flat rear side being adapted to butt against a wall, further comprising at least a first straight shaft (11, 13) penetrating the body (16, 36) at an angle with respect to the plane of the body's rear side, whereby the shaft (11, 13) being adapted to guide a pin-like fastening means to be driven into the wall for affixing the fastening element to the wall, the body further comprising at least one pre-fixing element (20, 22, 46, 48, 50) protruding from the body's rear side and being adapted to penetrate the wall when the body (16, 36) is brought in contact with the wall.

2. The fastening element according to claim 1, wherein the pre-fixing element (20, 22, 46, 48, 50) is pointing in a direction substantially perpendicular normal to the plane of the body's rear side.

3. The fastening element according to claim 1, wherein the pre-fixing element (20, 22, 46, 48, 50) being shaped as a pointed pin.

4. The fastening element according to claim 1, wherein a first and second shaft (11, 13) being arranged near a body's upper edge and pointing downwards at an angle between 20° and 40° with respect to the surface normal of the body's rear side and wherein the first and second horizontally spaced shafts (11, 13) are further pointing towards each other in a projection perpendicular to the rear side's plane.

5. The fastening element according to claim 1, further comprising at least three pre-fixing elements (46, 48, 50) being evenly distributed over the body's rear side.

6. The fastening element according to claim 1, further comprising at least two pre-fixing elements (20, 22) being arranged at the corners of an imaginary rhombus at the body's rear side.

7. The fastening element according to claim 1, wherein the front side surface of the body (16) is substantially flat.

8. The fastening element according to claim 1, wherein the body (16, 36) further comprises a lower hook-like portion (18, 38) being adapted to hang objects thereon.

9. The fastening element according to claim 8, wherein the hook portion (38) is pivot-mounted to the body (36).

10. The fastening element according to claim 1, wherein the body (16, 36) is comprised of molded plastic material.

11. The fastening element according to claim 10, wherein the pre-fixing elements (20, 22, 46, 48, 50) are molded in the body (16, 36).

12. Fastening means being adapted to fit into the at least one shaft (11, 13) of a fastening element according to claim 1, the fastening means comprising a wall-penetrating pointed pin (12, 32) having a pan head (12).

13. Fastening means according to claim 12, wherein the pan head (12) has a circumferential notch (58) and an adjacent socket (60), being adapted to butt against the front surface of the fastening element's body (16, 36).
